(19) United States
(12) Patent Application Publication
(10) Pub. No.: US 2013/0153515 A1
(43) Pub. Date: Jun. 20, 2013

(54) WATER TREATMENT APPARATUS AND SYSTEMS

(71) Applicants: Dong-Keun Kang, Goyang-Si (KR); Beom-Keum Kwon, Seoul (KR)

(72) Inventors: Dong-Keun Kang, Goyang-Si (KR); Beom-Keum Kwon, Seoul (KR)

(73) Assignee: EMPIRE TECHNOLOGY DEVELOPMENT LLC, Wilmington, DE (US)

(21) Appl. No.: 13/818,285

(22) PCT Filed: Oct. 26, 2010
(86) PCT No.: PCT/US10/54055

§ 371 Date: Feb. 21, 2013

(51) Int. Cl. C02F 1/32

(52) U.S. Cl. CPC C02F 1/32
USPC 210/748.14; 210/205; 210/200; 210/196; 210/202; 210/201

(57) ABSTRACT

Apparatus and systems for water treatment, as well as methods for treating water, are provided. An apparatus for water treatment may include one or more reactors configured for water treatment, one or more light sources configured to provide ultraviolet light inside the one or more reactors, a photocatalyst positioned in each of the one or more reactors and configured to receive the ultraviolet light from the one or more light sources, and a pure oxygen source coupled to the one or more reactors and configured to supply pure oxygen to the water.

### TECHNICAL FIELD

The present disclosure generally relates to water treatment apparatus and systems.

### BACKGROUND

The presence of harmful impurities and pollutants in water supplies and in the discharge of wastewater from chemical industries, power plants, and agricultural sources is an issue of major global concern. Thus, there is an interest in developing cost-effective water treatment processes.

For instance, in conventional water treatment technology, as an alternative method of preventing the production of trihalomethane (THM), which is a by-product of chlorine disinfection, ozone, which is a powerful oxidant and has a number of advantages in terms of water taste, improved precipitation, and increased biological activities, has been widely used. However, ozone reactions require a reactor of considerable size and the corresponding guarantee of sufficient reaction time. Thus, conventional ozone-based advanced oxidation treatment processes have disadvantages in terms of excessive cost and other operational issues. Further, ozone is extremely selective in terms of its reactivity with organic compounds in that it reacts slowly with the majority of organic pollutants, such as Geosmin, 2-methylisoborneol, and saturated hydrocarbons such as THM, pesticides, etc., or does not react with them at all. In addition, the oxidative ability of ozone is very sensitive to various operational conditions, such as pH, temperature, and salinity.

In a typical semiconductor manufacturing process, a significant amount of wastewater is generated because a large quantity of water is consumed in the course of removing contaminants from wafer surfaces. Semiconductor wastewater contains various harmful, environmental pollutants, such as organic solvents, acids, bases, salts, heavy metals, and other organic and inorganic compounds, which are very difficult to treat. In other words, standard physical/chemical wastewater treatment techniques have limitations with respect to their capability to deal with organic solvents and are equally inefficient in treating biological contaminants. Among the above pollutants, high concentrations of hydrogen peroxide (H₂O₂) are commonly used to clean semiconductors, yet there are no effective means of treating the residual hydrogen peroxide that is generated from these processes. Residual hydrogen peroxide is a powerful oxidizing agent and its presence in the wastewater discharge can have adverse effects on the environment.

### SUMMARY

Embodiments of apparatus and systems for water treatment and methods for treating water are disclosed herein. According to one aspect, an apparatus for water treatment includes one or more reactors configured for water treatment, one or more light sources configured to provide ultraviolet (UV) light inside the one or more reactors, a photocatalyst positioned in each of the one or more reactors and configured to receive the UV light from the one or more light sources, and a pure oxygen source coupled to the one or more reactors and configured to supply pure oxygen to the water.

According to another aspect, a system for water treatment includes one or more apparatus for water treatment described above and an analyzer unit coupled to the one or more apparatus and configured to analyze water from the apparatus.

According to still another aspect, a method for treating water includes the use of the apparatus or the system described above.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIGS. 1A-B are schematic diagrams showing a longitudinal sectional view and a cross-sectional view, taken along the A-A′ line of FIG. 1A, of an illustrative embodiment of an apparatus for water treatment.

FIGS. 2A-B are schematic diagrams showing a longitudinal sectional view and a cross-sectional view, taken along the B-B′ line of FIG. 2A, of an illustrative embodiment of a part of an apparatus for water treatment, respectively.

FIGS. 3A-B are schematic diagrams showing a longitudinal sectional view and a cross-sectional view, taken along the C-C′ line of FIG. 3A, of another illustrative embodiment of a part of an apparatus for water treatment, respectively.

FIG. 4 is a schematic diagram showing a longitudinal sectional view of another illustrative embodiment of a part of an apparatus for water treatment.

FIG. 5 is a schematic diagram showing an illustrative embodiment of a system for water treatment.

FIG. 6 is a flow diagram illustrating an embodiment of a method for treating water using the system for water treatment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

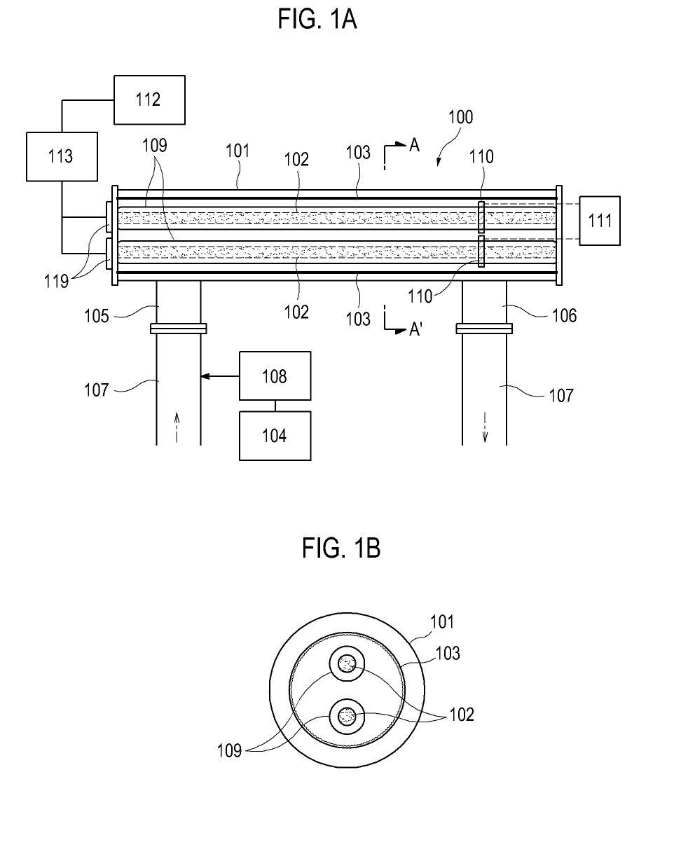

FIGS. 1A-B are schematic diagrams showing an illustrative embodiment of an apparatus for water treatment. As used herein, “water” may include water collected from any natural source, such as but not limited to rivers, lakes, ocean, etc., or from any artificial water supply, as well as wastewater containing various pollutants and contaminants from private use, industry (e.g. chemical, textile, etc), power plants, agricultural sources, etc. “Water treatment” refers to those processes used to make water more acceptable for an intended end-use, such as but not limited to drinking water, industrial, medical, agricultural, and various other uses. As depicted, in some embodiments, the apparatus for water treatment 100 may include, but is not limited to, one or more reactors 101, one or more light sources 102, a photocatalyst 103, and a pure oxygen source 104.

The one or more reactors 101 configured for water treatment may be made of a variety of materials including, but not limited to, plastic, glass, ceramic, and metal. In some embodiments, the plastic may include, but is not limited to, one or more of polyethylene, polypropylene, polyamide, polyester, polyimide, polystyrene, acrylonitrile-butadiene-styrene terpolymer, acrylic, fluorinated polymers, and the like. In addition, the glass may include, but is not limited to, one or more of soda-lime glass, quartz glass, borosilicate glass, acrylic glass, sugar glass, isinglass, aluminum oxynitride, and the like. Further, the ceramic may include, but is not limited to, one or more of alumina, zirconia, zirconia toughened alumina, steatite, mullite, cordierite, lava, Macor®, boron nitride, and the like. In addition, the metal may be, but is not limited to, one or more of iron, stainless steel, copper, titanium, aluminum, and the like.

In other embodiments, the inside surface of the one or more reactors 101 may be coated with a material which is resistant to chemicals/contaminants which may exist in the water to be treated or are generated as by-products of water treatment. The material resistant to chemicals/contaminants may include, without limitation, non-corrosive metals, such as stainless steel, titanium, and aluminum, fluoropolymers, such as polytetrafluoroethylene (PTFE), perfluoroalkoxy polymer resin (PFA), fluorinated ethylene-propylene (FEP), polyethylenetetrafluoroethylene (ETFE), polyvinylfluoride (PVF), polyethylenechlorotrifluoroethylene (ECTFE), polyvinylidene fluoride (PVDF), and polychlorotrifluoroethylene (PCTFE).

In certain embodiments, the one or more reactors 101 may be at least partially or completely coated with a metallic material (not shown) on the inside and/or outside surface of the one or more reactors 101 to reflect the UV light emitted by the one or more light sources 102 toward the inside of the one or more reactors 101, to increase UV light efficiency. In some embodiments, the portions partially coated with a metallic material may include from about 70% to less than 100%, from about 80% to less than 100%, from about 90% to less than 100%, from about 95% to less than 100%, from about 99% to less than 100%, from about 70% to about 99%, from about 70% to about 95%, from about 70% to about 90%, from about 70% to about 80%, from about 80% to about 90%, from about 90% to about 95%, or from about 95% to about 99% of the total inside and/or outside surface of the one or more reactors 101. In some embodiments, the metallic material may be, without limitation, one or more of aluminum, stainless steel, zinc oxide, iron oxide, magnesium oxide and titanium dioxide. In other embodiments, the metallic material may be the same as the photocatalyst 103.

The shape of the one or more reactors 101 may be, but is not limited to, a cylinder, sphere, polygonal prism, or polyhedron. When the one or more reactors 101 have a cylindrical shape, the length of the one or more reactors 101, for example, may range, without limitation, from about 30 cm to about 300 cm. In some embodiments, the length of the one or more reactors 101 may range from about 40 cm to about 300 cm, from about 50 cm to about 300 cm, from about 100 cm to about 300 cm, from about 200 cm to about 300 cm, from about 30 cm to about 40 cm, from about 30 cm to about 50 cm, from about 30 cm to about 100 cm, from about 30 cm to about 200 cm, from about 40 cm to about 50 cm, from about 50 cm to about 100 cm, or from about 100 cm to about 200 cm. In other embodiments, the length of the one or more reactors 101 may be about 30 cm, about 40 cm, about 50 cm, about 100 cm, about 200 cm, or about 300 cm. When the one or more reactors 101 have a cylindrical shape, the diameter of the one or more reactors 101, for example, may range, without limitation, from about 5 cm to 50 cm. In some embodiments, the diameter of the one or more reactors 101 may range from about 10 cm to about 50 cm, from about 20 cm to about 50 cm, from about 30 cm to about 50 cm, from about 5 cm to about 10 cm, from about 5 cm to about 20 cm, from about 5 cm to about 30 cm, from about 10 cm to about 20 cm, or from about 20 cm to about 30 cm. In other embodiments, the diameter of the one or more reactors 101 may be about 5 cm, about 10 cm, about 20 cm, about 30 cm, or about 50 cm. The dimensions of the one or more reactors 101 having shapes other than the cylindrical shape may be within the same range with those mentioned for the reactors having the cylindrical shape.

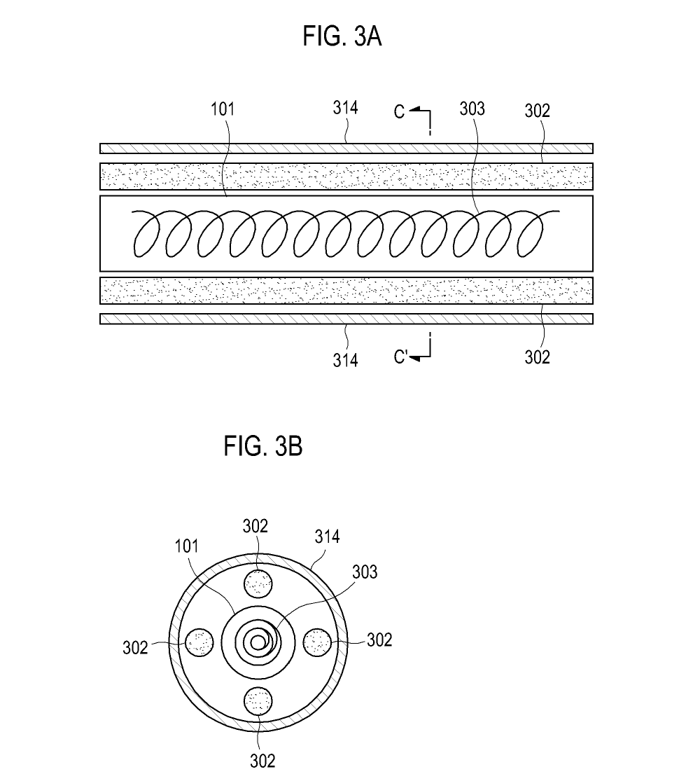

The one or more light sources 102 are configured to provide UV light inside the one or more reactors 101. In some embodiments, the one or more light sources 102 may be positioned inside the one or more reactors 101, as illustrated in FIGS. 1A-B. In other embodiments, the one or more light sources 302, 402 may be positioned outside the one or more reactors 101, as illustrated in FIGS. 3A-B and 4. In some embodiments, the distance between the one or more light sources 102, 302, 402 and the perimeter of the one or more reactors 101, for example, may range, without limitation, from about 0.5 cm to about 25 cm, from about 1 cm to about 25 cm, from about 3 cm to about 25 cm, from about 5 cm to about 25 cm, from about 10 cm to about 25 cm, from about 15 cm to about 25 cm, from about 0.5 cm to about 1 cm, from about 0.5 cm to about 3 cm, from about 0.5 cm to about 5 cm, from about 0.5 cm to about 10 cm, from about 0.5 cm to about 15 cm, from about 1 cm to about 3 cm, from about 3 cm to about 5 cm, from about 5 cm to about 10 cm, or from about 10 cm to about 15 cm. In other embodiments, e.g., if the number of the one or more light sources 102, 302 is two or more, the distance between the one or more light sources 102, 302, without limitation, may range from about 1 cm to about 10 cm, from about 3 cm to about 10 cm, from about 5 cm to about 10 cm, from about 1 cm to about 3 cm, from about 1 cm to about 5 cm, or from about 3 cm to about 5 cm.

When the one or more light sources 302, 402 are positioned outside the one or more reactors 101, the material for the one or more reactors 101 may be selected to be at least partially transparent to the UV light emitted from the one or more light sources 302, 402, such as, but not limited to, glass, silica, fluorides, gemstones, and polymer. In some embodiments, the glass may include, but is not limited to, one or more of soda-lime glass, quartz glass, borosilicate glass, acrylic glass, sugar glass, isinglass (Muscovy glass), aluminum oxynitride, and the like. Further, the silica may be, without limitation, one or more of fused quartz, crystal and fumed silica, while the fluorides may be, without limitation, one or more of calcium fluoride, magnesium fluoride, and barium fluoride. In addition, the gemstones may include, but are not limited to, sapphire, ruby, and diamond. Further, the polymer may be, without limitation, one or more of acryl resin, polyester, polyethylene, polypropylene, polyolefin, polyvinyl butyral, polyurethane, and fluorinated polymers.

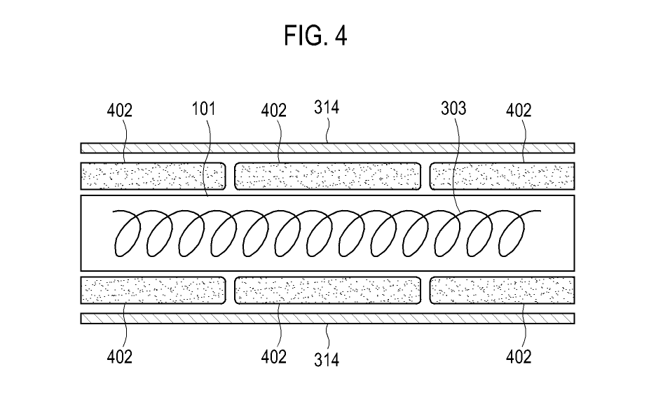

In another embodiment, the one or more light sources 402 may be configured to be connected in series, as illustrated in FIG. 4. In certain embodiments, the longitudinal end-to-end distance between the serially connected one or more light sources 402 may range, without limitation, from about 0.1 cm to about 5 cm, from 0.5 cm to about 5 cm, from about 1 cm to about 5 cm, from about 2 cm to about 5 cm, from about 3 cm to about 5 cm, from about 4 cm to about 5 cm, from about 0.1 cm to about 0.5 cm, from about 0.1 cm to about 1 cm, from about 0.1 cm to about 2 cm, from about 0.1 cm to about 3 cm, from about 0.1 cm to about 4 cm, from about 0.5 cm to about 1 cm, from 1 cm to about 2 cm, from about 2 cm to about 3 cm, or from about 3 cm to about 4 cm.

In certain embodiments, the one or more light sources 102, 302, 402 may be positioned along the longitudinal axis of the one or more reactors 101, as depicted in FIGS. 1-4.

The one or more light sources 102, 302, 402 may include, but are not limited to, UV fluorescent lamps that emit UV light due to the peak emission of the mercury within the bulb, UV light emitting diodes manufactured to emit light in the UV range, UV laser diodes and UV solid-state lasers manufactured to emit light in the UV range, and gas-discharge lamps, such as argon and deuterium lamps.

The one or more light sources 102, 302, 402 may have a shape and size corresponding to those of the one or more reactors 101 and thus may have a substantially similar shape and size with the one or more reactors 101. In some embodiments, the length of the one or more light sources 102, 302 may be slightly longer than that of the one or more reactors 101 so that the one or more light sources 102, 302 can be connected to a power source 112 without the danger of electrical short or other electrical damage. In other embodiments, the end of the one or more light sources 102, 302, 402 may be connected to power terminals 119 which are located outside the one or more reactors 101 in which the water is held, in order to prevent electrical short or other electrical damage caused by the water itself or the reaction between the water and the one or more light sources 102, 302, 402.

During the operation of the water treatment apparatus 100, the UV light emitted from the one or more light sources 102, 302, 402 reacts with hydrogen peroxide which may be added into the water and/or may already be present in the water as by-products from a semiconductor manufacturing process, for example, resulting in the generation of hydroxide radicals, as shown in Reaction 1 below.

H₂O₂+UV light→2.OH (1)

In Reaction 1 above, 1 mole of hydrogen peroxide will react with the UV energy and decompose into 2 moles of hydroxide radicals.

The UV light intensity, for example, may range, without limitation, from 1 to 600 mW/cm². In some embodiments, the UV light intensity may range from about 50 mW/cm² to about 600 mW/cm², from about 100 mW/cm² to about 600 mW/cm², from about 200 mW/cm² to about 600 mW/cm², from about 400 mW/cm² to about 600 mW/cm², from about 1 mW/cm² to about 50 mW/cm², from about 1 mW/cm² to about 100 mW/cm², from about 1 mW/cm² to about 200 mW/cm², from about 1 mW/cm² to about 400 mW/cm², from about 50 mW/cm² to about 100 mW/cm², from about 100 mW/cm² to about 200 mW/cm², or from about 200 mW/cm² to about 400 mW/cm². The suitable UV energy level (UV light dose) per unit volume of water to be treated may vary depending on the characteristics of the water to be treated (e.g., industrial wastewater discharged from chemical sources such as semiconductor manufacturing facilities or sanitary wastewater from private use) and the concentration of contaminants in the water to be treated.

The concentration of hydrogen peroxide, for example, may range, without limitation, from 0.0001 to 2M. In some embodiments, the UV light intensity may range from about 0.001 M to about 2 M, from about 0.01 M to about 2 M, from about 0.1 M to about 2 M, from about 1 M to about 2 M, from about 0.0001 M to about 0.001 M, from about 0.0001 M to about 0.01 M, from about 0.0001 M to about 0.1 M, from about 0.0001 M to about 1 M, from about 0.001 M to about 0.01 M, from about 0.01 M to about 0.1 M, or from about 0.1 M to about 1 M. Hydrogen peroxide may be added into the water by, for example, a control valve-equipped conduit. In some embodiments, the water treatment apparatus 100 may have a conduit equipped with one or more control valves configured to add hydrogen peroxide into the water treatment apparatus 100 and control the concentration of hydrogen peroxide. In some embodiments, the one or more valves may be automated and controlled by an electronic device. For example, the water treatment apparatus 100 may include, by way of non-limiting example, a control device (not shown). In a very basic configuration, the control device typically includes one or more processors and a system memory. A memory bus may be used for communicating between the processor and the system memory. Depending on the desired configuration, the processor may be of any type including but not limited to a microprocessor (μP), a microcontroller (μC), a digital signal processor (DSP), or any combination thereof. Depending on the desired configuration, the system memory may be of any type including but not limited to volatile memory (such as RAM), non-volatile memory (such as ROM, flash memory, etc.) or any combination thereof. The system memory may include an operating system, one or more applications, and program data. The control device may have additional features or functionality, and additional interfaces to facilitate communications between the basic configuration and any required devices and interfaces. For example, a bus/interface controller may be used to facilitate communications between the basic configuration and one or more data storage devices via a storage interface bus. The data storage devices may be removable storage devices, non-removable storage devices, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. The control device may also be implemented as a personal computer including both laptop computer and non-laptop computer configurations. Suitable concentrations of hydrogen peroxide per unit volume of water to be treated may vary depending on the characteristics of the water to be treated.

The hydroxide radicals generated by UV may then attack organic contaminants in the water via an oxidation process. Further, in addition to the hydroxide radicals, various other radical species, such as hydroperoxyl radicals (HO₂.), superoxide anion radicals (O₂⁻.), and the like, may be formed by chain reactions, as shown in Reactions 2 to 4 below.

.OH+H₂O₂→HO₂.+H₂O (2)

O⁻.+H⁺ [symbol] .OH (pKa=11.8) (3)

HO₂. [symbol] O₂⁻.+H⁺ (pKa=4.8) (4)

Further, according to the disproportionation reactions of the formed hydroperoxyl radicals and the superoxide anion radicals, the reactions between HO₂. and HO₂. and the reaction between HO₂. and O₂⁻. progress relatively rapidly to form hydrogen peroxide, as shown in Reactions 5 and 6 below.

HO₂.+HO₂→H₂O₂+O₂ (5)

HO₂.+O₂⁻.+H⁺→H₂O₂+O₂ (6)

The formed hydrogen peroxides then contribute to the formation of hydroxide radicals, as shown in Reaction 1 above.

The photocatalyst 103 may be associated with each of the one or more reactors 101 and configured to receive the UV light from the one or more light sources 102, as depicted in FIGS. 1A-B. In some embodiments, the photocatalyst 103, 203, 303 may be configured to exist in an immobilized form on the substrate in the shape of, such as, but not limited to, particles, plate, sheet, wire and mesh. In certain embodiments, the photocatalyst 103 may at least partially or completely coat the interior surface of the one or more reactors 101, as shown in FIGS. 1A-B. In some embodiments, the portions partially coated with the photocatalyst 103 may include from about 20% to less than 100%, from about 40% to less than 100%, from about 60% to less than 100%, from about 80% to less than 100%, from about 90% to less than 100%, from about 20% to about 90%, from about 20% to about 80%, from about 20% to about 60%, from about 20% to about 40%, from about 40% to about 60%, from about 60% to about 80%, or from about 80% to about 90% of the total interior surface of the one or more reactors 101. The photocatalyst 103 may be coated on the interior surface of the one or more reactors 101 by methods such as, but not limited to, spray coating, roller coating, chemical vapor depositions, physical vapor depositions, and chemical and electrochemical techniques.

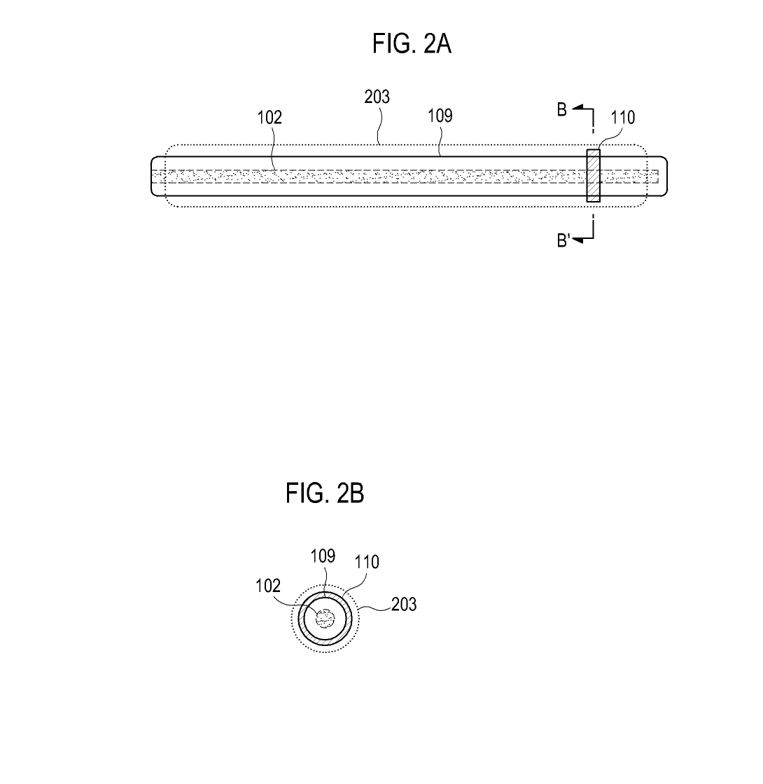

In other embodiments, the photocatalyst 203 may wrap around the outside of the one or more light sources 102, as depicted in FIGS. 2A-B. The photocatalyst 203 that is capable of partially or entirely wrapping around the outside of the one or more light sources 102 may be prepared by first providing a sheet or mesh made with flexible material, such as, but without limitation, metals, fabrics or polymers, and then coating it with a photocatalyst solution by one of the above described methods. Then, the coated sheet or mesh may be wrapped around and attached to the outside of the one or more light sources 102. In certain embodiments, the end portions of the coated sheet or mesh may have grooves to facilitate connection to each other to form a continuous sheet. In other embodiments, the end portions of the coated sheet or mesh may be spot welded together.

In certain embodiments, the photocatalyst 303 may be placed in the one or more reactors 101 in the form of a helical wire, as illustrated in FIGS. 3A-B and 4. The photocatalyst 303 in the form of a wire may be prepared by first providing a wire made of metal or any other suitable material, such as, but without limitation, polymer or glass fiber, and then coating it with a photocatalyst solution by one of the above described methods.

The photocatalyst 103, 203, 303 may include a material such as, but not limited to, TiO₂, ZnO, WO₃, CdS, Fe₂O₃, MnO₂, CeO₂, CuO, and RTiO₃ compounds, where R is Sr, Ba, Ca, Al, or Mg. In addition, the photocatalyst 103, 203, 303 may be metallized with at least one metal such as, but not limited to, Pt, Pd, Au, Ag, Re, Ru, Fe, Cu, Bi, Ta, Ti, Ni, Mn, V, Cr, Y, Sr, Li, Co, Nb, Mo, Zn, Sn, Sb, and Al.

The efficiency of the water treatment apparatus 100 in removing various contaminants from the water may increase with increasing amounts of the photocatalyst until the photocatalyst is completely absorbed by the light energy. Excess amounts of the photocatalyst may decrease light penetration via a shielding effect caused by the overloading of the photocatalyst, resulting in reduced efficiencies of the water treatment apparatus.

During the operation of the water treatment apparatus 100, the photocatalyst 103, 203, 303 reacts with the UV emitted from the one or more light sources 102, 302, 402, where, as shown in Reactions 7 to 10 below, electrons (hydrated electron e−), holes (h+) and hydroxide radicals are formed to contribute to the treatment of water.

photocatalyst+UV light [symbol] h⁺+e⁻ (7)

h⁺+H₂O→.OH (8)

h⁺+OH⁻→·OH (9)

H₂O₂+e⁻→.OH+OH⁻ (10)

As shown in the above reactions, by use of the photocatalyst, the combination of UV light and hydrogen peroxide yields more hydroxide radicals, as well as various other radical species, such as hydroperoxyl radicals (HO₂.) and superoxide anion radicals (O₂⁻.), resulting in a more effective water treatment than the conventional physical/chemical water treatment methods.

The pure oxygen source 104 is directly or indirectly coupled to the one or more reactors 101 and configured to supply pure oxygen to the water in the one or more reactors 101, as depicted in FIG. 1. In some embodiments, the pure oxygen source 104 may be, without limitation, an oxygen tank or a chemical oxygen generator which is a device that releases oxygen produced by a chemical reaction, where usually, without limitation, inorganic superoxide, chlorate, or perchlorate may be used as the oxygen source.

By introducing a supply of pure oxygen from the pure oxygen source 104 into the water treatment process, the electrons generated in Reaction 7 above react with oxygen to produce superoxide anion radicals by Reaction 11 below, thereby preventing the recombination of electrons and electron holes and thus raising the efficiency of the photocatalytic process.

e⁻+O₂→O₂⁻. (11)

A suitable oxygen flow rate for the water treatment process, for example, may range, without limitation, from about 0.001 to about 50 L/min. In some embodiments, the oxygen flow rate may range from about 0.01 L/min to about 50 L/min, from about 0.1 L/min to about 50 L/min, from about 1 L/min to about 50 L/min, from about 10 L/min to about 50 L/min, from about 20 L/min to about 50 L/min, from about 30 L/min to about 50 L/min, from about 40 L/min to about 50 L/min, from about 0.001 L/min to about 0.01 L/min, from about 0.001 L/min to about 0.1 L/min, from about 0.001 L/min to about 1 L/min, from about 0.001 L/min to about 10 L/min, from about 0.001 L/min to about 20 L/min, from about 0.001 L/min to about 30 L/min, from about 0.001 L/min to about 40 L/min, from about 0.01 L/min to about 0.1 L/min, from about 0.1 L/min to about 1 L/min, or from about 1 L/min to about 10 L/min, from about 10 L/min to about 20 L/min, from about 20 L/min to about 30 L/min, or from about 30 L/min to about 40 L/min.

Depending on various factors such as the intensity and the irradiation length of the UV light, the concentration of the hydrogen peroxide, the amount of the photocatalyst and the flow rate of the supplied pure oxygen, the efficiency of the water treatment apparatus in removing contaminants from the water may differ.

As depicted in FIG. 1, each of the one or more reactors 101 may further include at least one water inlet port 105 configured to receive water to be treated and/or at least one water outlet port 106 configured to remove treated water which has passed through the one or more reactors 101. The at least one water inlet port 105 and the at least one water outlet port 106 may be made of any material as long as it is not vulnerable to or likely to be damaged by the water to be treated or the treated water. By way of non-limiting examples, plastic, glass, ceramic, and metal mentioned above as suitable materials for the one or more reactors 101 may be used to make the at least one water inlet port 105 and the at least one water outlet port 106.

In addition, as depicted in FIG. 1, the apparatus for water treatment 100 may further include one or more water channels 107 directly or indirectly associated with the one or more reactors 101 and configured to provide water to or remove water from the one or more reactors 101, as shown in FIG. 1. In some embodiments, the one or more water channels 107 may be indirectly associated with the one or more reactors 101 through the at least one water inlet port 105 and/or the at least one water outlet port 106, as depicted in FIG. 1. The one or more water channels 107 may be made of the same material as that used for making the one or more reactors 101. Further, the one or more water channels 107 may be made of the same material as that used for making the at least one water inlet port 105 and the at least one wastewater outlet port 106.

In some embodiments, the at least one inlet wastewater port 105 and the at least one or more outlet port 106 may have one or more valves (not shown) which may be operated to introduce and release the water into and from the one or more reactors 101, respectively, and control the water flow. In certain embodiments, the one or more valves may be automated and controlled by a control device, such as but not limited to a computer.

In other embodiments, the pure oxygen source 104 may be coupled to a water channel 107 positioned upstream of the one or more reactors 101, as depicted in FIG. 1.

The apparatus for water treatment 100 may further include a control device 108 which is coupled to the pure oxygen source 104 and configured to regulate an amount and/or rate of the pure oxygen supplied to the water, as depicted in FIG. 1. The control device 108 may be, but is not limited to, a computer.

In some embodiments, the apparatus for water treatment 100 optionally includes one or more sleeves 109 configured to prevent contact between the one or more light sources 102 and the water, as depicted in FIGS. 1 and 2A-B. The cross-sectional shape of the one or more sleeves 109 may be, but is not limited to, a circle, triangle, square, rectangle, and polygon.

The one or more sleeves 109 may be at least partially transparent to the UV light emitted from the one or more light sources 102 and configured such that the UV light is able to interact with the photocatalyst 103 in the one or more reactors 101. In addition, since the one or more sleeves 109 may directly contact the water, the one or more sleeves 109 may be made of any material resistant to chemicals which may be contained in the water to be treated or the treated water. By way of non-limiting example, the one or more sleeves 109 may be made of one or more materials such as glass, silica, fluorides, gemstones, and polymer, as long as they are at least partially transparent to UV and resistant to chemicals. In some embodiments, the glass may include, but is not limited to, one or more of soda-lime glass, quartz glass, borosilicate glass, acrylic glass, sugar glass, isinglass (Muscovy glass), aluminum oxynitride, and the like. Further, the silica may be, without limitation, one or more of fused quartz, crystal, and fumed silica, while the fluorides may be, without limitation, one or more of calcium fluoride, magnesium fluoride, and barium fluoride. The gemstones may be, without limitation, sapphire, ruby, and diamond. The polymer may be, without limitation, one or more of acryl resin, polyester, polyethylene, polypropylene, polyolefin, polyvinyl butyral, polyurethane, and fluorinated polymers.

As depicted in FIGS. 1 and 2A-B, the apparatus for water treatment 100 may further include one or more cleaning devices 110 configured to attach to the outside surface of the one or more sleeves 109 and to controllably move along the length of and/or rotate around the one or more sleeves 109. The one or more cleaning devices 110 are capable of removing any material that may have accumulated on the outside of the one or more sleeves 109 and thus enhance the efficiency of the interactions between the UV light and the water to be treated.

The one or more cleaning devices 110 may be made of, but not limited to, elastomeric materials, such as vulcanized rubber, synthetic rubber, thermoplastic elastomer (TPE), and soft materials, such as textile, woven fabric or non-woven fabric. In some embodiments, the one or more cleaning devices 110 may have a rigid core made of hard materials, such as metal, plastic or ceramic, associated with a soft/elastomeric shell or tip made of the above mentioned elastomeric materials or soft materials on the outside or at the end of the rigid core, where the soft/elastomeric shell or tip is in contact with the one or more sleeves 109. The cross-sectional shape of the one or more cleaning devices 110 may be similar to that of the one or more sleeves 109. The one or more cleaning devices 110 may move in response to various power sources including, but not limited to, magnetic force, a hydraulic actuator, and electrical power. In one embodiment, coils may be placed on the outside of the one or more reactors 101 and magnets may be attached to the one or more cleaning devices 110 in order to drive the one or more cleaning devices 110 with a magnetic force. By applying a current to the coils and changing the frequency and direction of the current, a magnetic force is generated, thereby moving the cleaning devices 110. In another embodiment, a hydraulic actuator may be used, where the body of the actuator may be placed on the outside of the one or more reactors 101, and the pistons of the actuator may be located in the one or more reactors 101 and associated with the one or more cleaning devices 110. As depicted in FIG. 1, the apparatus for water treatment 100 may include a control device 111 to direct the movement of the cleaning device 110.

The apparatus for water treatment 100 may further include a power source 112 connected to the one or more light sources 102 and configured to provide the light sources with power, as depicted in FIG. 1. The power source 112 may include an electrical ballast that provides constant power and/or a circuit breaker. In addition, the apparatus for water treatment 100 may further include a control device 113 coupled to the power source 112 and configured to regulate the amount and/or type of power, as shown in FIG. 1. In some embodiments, the power source 112 may also supply power to the one or more cleaning devices 110.

The control device 108 configured to regulate the amount and/or rate of the pure oxygen supplied to the water, the control device 111 configured to direct the movement of the cleaning device, and the control device 113 configured to regulate the amount and/or type of power may be the same or different from each other, or may be assembled as a single device.

Referring to FIGS. 3A-B and 4, the apparatus for water treatment 100 may further include a housing 314 to prevent the UV from transmitting outside of the apparatus for water treatment 100. The housing 314 may be made of a variety of materials, without limitation, such as ceramic, metal, plastic and wood. In some embodiments, one or more cleaning devices may be further placed on the interior surface of the one or more reactors 101 to reduce the deterioration of UV transmittance due to the deposition of contaminants on the interior surface of the one or more reactors 101.

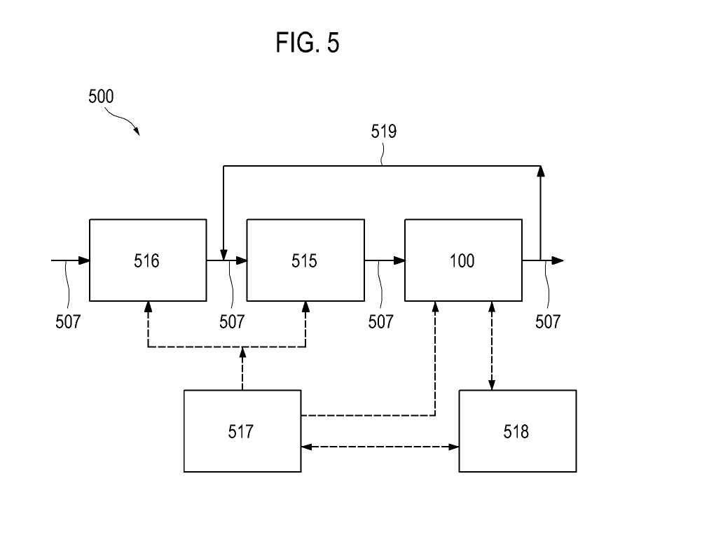

FIG. 5 is a schematic diagram of an illustrative embodiment of a system for water treatment 500. As depicted, the system for water treatment 500 includes one or more apparatus for water treatment 100 described above and an analyzer unit 518 coupled to the one or more apparatus for water treatment 100 and configured to analyze water from the apparatus 100. In non-limiting exemplary embodiments, the analyzer unit 518 may measure the concentrations of hydrogen peroxide, oxygen, and/or particular contaminants, as well as the change in the concentrations. In certain embodiments, the analyzer unit 518 may be an optical absorption spectrometer or a fluorometer. In some embodiments, materials which are capable of combining with hydrogen peroxide, oxygen, and/or other contaminants to prepare fluorescent compounds detectable by a fluorometer may be added to the one or more apparatus for water treatment 100 or the analyzer unit 518, whereby various process conditions, such as the water flow, the flow rate of pure oxygen being supplied to the water, the number and order of recycling, etc., may be determined.

In some embodiments, the system for water treatment 500 may further include one or more water conduits 507 directly or indirectly associated with the one or more apparatus for water treatment 100 and configured to provide water to or remove water from the one or more apparatus for water treatment 100, as illustrated in FIG. 5. In certain embodiments, the one or more water conduits 507 may be similar to the one or more water channels 107 in the one or more apparatus for water treatment 100 in terms of material and/or function. In other embodiments, the one or more water conduits 507 may be, without limitation, a tubing, part of a delivery system, or part of a semiconductor plant.

In certain embodiments, the system for water treatment 500 may further include a filtration device 515 positioned upstream of the water treatment apparatus 100, as illustrated in FIG. 5. The filtration device 515 may include various filters, which can be appropriately selected according to the conditions of the water to be treated and the type of contaminants in the water. Although not wishing to be limited by the following description, the filtration device 515 may include a stage 1 filter to handle particles in the water to be treated that are greater than 10 micron in size and a stage 2 filter that can filter particles down to 1 micron in size. The filtration device 515 and/or filters in the filtration device 515 may be replaced or cleaned periodically to prevent clogging. In some embodiments, ultrafiltration membranes using polymer membranes with chemically formed microscopic pores can be used as the filtration device 515 to filter out various contaminants including microorganisms. In such a case, the type of membrane material can be determined depending on how much pressure is needed to drive the water through the membrane and the size of the microorganisms to be filtered out. In other non-limiting exemplary embodiments, ion exchange systems using columns packed with ion exchange resin or zeolite may also be used as the filtration device 515 to remove toxic ions such as nitrate, nitrite, lead, mercury, arsenic and many others.

Further, as depicted in FIG. 5, the system for water treatment 500 may optionally include one or more recycle channels 519 configured to recycle treated water which has passed through the water treatment apparatus 100 back to a water conduit 507 positioned upstream of the water treatment apparatus 100 for further, optionally continuous, iterative treatment. In some embodiments, the one or more recycle channels 519 may be similar to the one or more water channels 107 in the one or more apparatus for water treatment 100 in terms of material or shape, or may be any kind of tubing or conduit.

In some embodiments, the system for water treatment 500 may further include one or more pumps 516 coupled to the water treatment apparatus 100 and the filtration device 515 to move the water to be treated though the filtration device 515 and the one or more reactors in the water treatment apparatus 100, as depicted in FIG. 5. By way of non-limiting example, a syringe pump may be used as the one or more pumps 516, but any other pump known to be effective for moving fluid may be used. In some embodiments, the system for water treatment 500 may include a power source (not shown) connected to the one or more pumps 516 and the one or more light sources in the water treatment apparatus 100 to provide power.

In other embodiments, the system for water treatment 500 may further include a buffer chamber (not shown) positioned between the filtration device 515 and the water treatment apparatus 100 and configured to prevent overflow of water and to maintain a constant volume of water in the system for water treatment 500. In a non-limiting embodiment, the buffer chamber may be a simple reservoir or part of the one or more water conduits 507 having a larger diameter than other parts.

As depicted in FIG. 5, the system for water treatment 500 may further include a controller 517 configured to control the filtration device 515, the one or more pumps 516, and the one or more light sources in the water treatment apparatus 100. Further, the controller 517 may also be configured to be connected with the analyzer unit 518 to control the water flow going into/out of the water treatment apparatus 100 (and the amount of the contaminants) depending on the analysis results from the analyzer unit 518. In addition, the controller 517 may also be connected with the various control devices in the water treatment apparatus 100, e.g., the control device 108 configured to regulate the amount and/or rate of the pure oxygen supplied to the water, the control device 111 to direct the movement of the cleaning device, and/or the control device 113 configured to regulate the amount and/or type of power. In certain embodiments, the controller 517 may be the same as any or all of the control device(s) described above.

In some embodiments, the above described control devices and/or the controller 517 may operate under the control of a computer program stored on a hard disk drive or by other computer programs, such as programs stored on a removable disk. In certain embodiments, the above described control devices and/or the controller 517 may include a data acquisition system, an analog-to-digital converter, and a personal computer. The above described control devices and/or the controller 517 may receive input signals from various components of the apparatus/system and control a particular parameter of the apparatus/system based on these signals. For example, the control devices and/or the controller 517 may be electrically coupled to the valves in the at least one water inlet port 105 and the at least one water outlet port 106, the pure oxygen source 104, the cleaning device 110, the power source 112, the analyzer unit 518, the pump 516, and/or the filtration device 515, enabling relatively instantaneous adjustments to be made regarding the water treatment conditions within the water treatment apparatus/system.

In illustrative embodiments, the water treatment apparatus 100 in the system for water treatment 500 may be connected in series, in parallel, or a combination thereof.

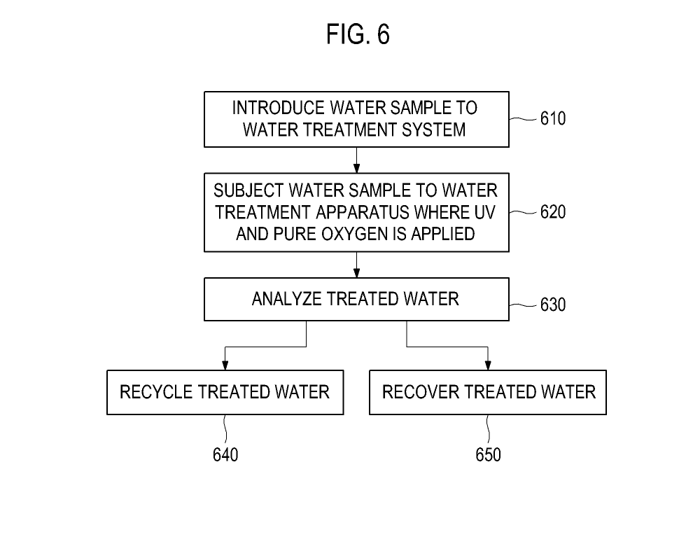

FIG. 6 is a flow diagram illustrating an embodiment of the method for treating water using the system for water treatment 500. At block 610, a water sample to be treated may be introduced into the system for water treatment 500.

At block 620, the water sample may be introduced into the water treatment apparatus 100 where UV light is applied under the supply of pure oxygen to remove various contaminants from the water sample.

At block 630, the water treated by the water treatment apparatus 100 may be analyzed to measure the concentrations of hydrogen peroxide, oxygen, and/or specific contaminants and assess the conditions of the treated water. The observed analytical data can be used as a yardstick for determining whether to recycle or recover the treated water sample. For example, if the analytical data indicate that the purification degree of the water sample is below the target value, the treated water may be recycled back to a water conduit positioned upstream of the water treatment apparatus 100 for further treatment (block 640). On the other hand, if the analytical data indicate that the treated water has reached the target purification value, the treated water may be recovered (block 650).

In certain embodiments, the system for water treatment 500 may be installed as a part of a semiconductor manufacturing line to treat wastewater. In conventional semiconductor manufacturing lines, the wastewater that is produced in each section of the line is not pre-processed but instead collected first and treated subsequently. As a result, the amount of wastewater to be treated becomes quite large, leading to economic drawbacks relating to high processing costs. Thus, even without the treatment for biological contaminants which is potentially expected to be mandated by regulations, the cost for treating wastewater is extremely high. Therefore, pre-treating wastewater at or near the source where the amount of wastewater is small is a more effective alternative method for treating wastewater. Thus, according to the present disclosure, a compact water treatment pre-processing system that treats water at each or a few semiconductor manufacturing line(s) in a simple, yet effective manner can be utilized.

The water treatment apparatus/system utilizes the high energy UV light/photocatalytic process to maximize the generation of powerful hydroxide radicals and treat water more effectively. Further, the water treatment apparatus/system is advantageous in that it is capable of making use of the residual hydrogen peroxide present in the water and employs a continuous oxygen supply to the reaction in order to enhance the efficiency of water treatment.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, will be apparent. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. An apparatus for water treatment comprising:
one or more reactors configured for water treatment;
one or more light sources configured to provide ultraviolet light inside the one or more reactors;
a photocatalyst positioned in each of the one or more reactors and configured to receive the ultraviolet light from the one or more light sources, wherein the photocatalyst at least partially wraps around an outside of the one or more light sources; and
a pure oxygen source coupled to the one or more reactors and configured to supply pure oxygen to the water.

2. The apparatus of claim 1, wherein each of the one or more reactors include at least one of:
one water inlet port configured to receive water to be treated, or
one water outlet port configured to remove treated water which has passed through the one or more reactors.

3. (canceled)

4. The apparatus of claim 1 further comprising:
one or more water channels associated with the one or more reactors and configured to provide water to or remove water from the one or more reactors.

5. The apparatus of claim 1, wherein the one or more light sources are positioned inside the one or more reactors, are positioned along a longitudinal axis of the one or more reactors, or are positioned outside the one or more reactors.

6-7. (canceled)

8. The apparatus of claim 1, wherein the photocatalyst at least partially coats interior surfaces of the one or more reactors or wherein the photocatalyst is configured in the form of particles, plate, sheet, wire or mesh.

9-12. (canceled)

13. The apparatus of claim 1 further comprising:
a control device coupled to the pure oxygen source and configured to regulate an amount and/or rate of the pure oxygen supplied to the water,
wherein the pure oxygen source is coupled to a water channel positioned upstream of the one or more reactors.

14. The apparatus of claim 1, wherein the one or more reactors are made of plastic, glass, ceramic or metal.

15-18. (canceled)

19. The apparatus of claim 1, wherein the one or more reactors are coated with a metallic material to reflect the ultraviolet light from the one or more light sources.

20. (canceled)

21. The apparatus of claim 1 further comprising:
one or more sleeves configured to prevent contact between the one or more light sources and the water.

22. The apparatus of claim 21, wherein the one or more sleeves are made of a material at least partially transparent to ultraviolet light.

23. (canceled)

24. The apparatus of claim 21 further comprising:
one or more cleaning devices configured to attach to an outside surface of the one or more sleeves and to controllably move along the length of and/or controllably rotate around the one or more sleeves.

25. The apparatus of claim 1 further comprising:
a power source connected to the one or more light sources and configured to provide power.

26. (canceled)

27. A system for water treatment comprising:
one or more apparatus for water treatment, wherein the apparatus comprises:
one or more reactors configured for water treatment;
one or more light sources configured to provide ultraviolet light inside the one or more reactors;
a photocatalyst positioned in each of the one or more reactors and configured to receive the ultraviolet light from the one or more light sources;
one or more sleeves configured to prevent contact between the one or more light sources and the water;
one or more cleaning devices configured to attach to an outside surface of the one or more sleeves and to controllably move along the length of and/or controllably rotate around the one or more sleeves; and
a pure oxygen source coupled to the one or more reactors and configured to supply pure oxygen to the water; and
an analyzer unit coupled to the one or more apparatus and configured to analyze water from the apparatus.

28. The system of claim 27 further comprising at least one of:
at least one water inlet port in the one or more reactors through which water to be treated can be introduced into the one or more reactors; or
at least one water outlet port in the one or more reactors configured to remove treated water which has passed through the one or more reactors.

29. (canceled)

30. The system of claim 27 further comprising:
one or more water conduits associated with the one or more apparatus and configured to provide water to or remove water from the one or more apparatus.

31. The system of claim 30, wherein the one or more water conduits are a tubing, part of a delivery system, or part of a semiconductor plant.

32. The system of claim 27 further comprising:
one or more recycle channels configured to recycle treated water which has passed through the water treatment apparatus back to a water conduit positioned upstream of the water treatment apparatus.

33. The system of claim 27 further comprising:
a filtration device positioned upstream of the water treatment apparatus.

34. The system of claim 33 further comprising:
one or more pumps coupled to the water treatment apparatus and the filtration device to move the water to be treated through the filtration device and the one or more reactors in the water treatment apparatus.

35. The system of claim 34 further comprising:
a power source connected to the one or more light sources in the water treatment apparatus and the one or more pumps to provide power.

36. The system of claim 33 further comprising:
a buffer chamber positioned between the filtration device and the water treatment apparatus and configured to prevent overflow of water and to maintain a constant volume of water in the system.

37. The system of claim 34 further comprising:
a controller configured to control the filtration device, the one or more pumps, and the one or more light sources.

38. The system of claim 27, wherein the one or more water treatment apparatus are connected in series, in parallel, or a combination thereof.

39-40. (canceled)

41. The system of claim 27, wherein the photocatalyst at least partially wraps around an outside of the one or more light sources.

42. A method of treating water comprising:
subjecting a water sample to treatment in a water treatment apparatus, wherein the water apparatus comprises:
one or more reactors configured for treatment of the water sample;
one or more light sources configured to provide ultraviolet light inside the one or more reactors;
a photocatalyst positioned in each of the one or more reactors and configured to receive the ultraviolet light from the one or more light sources, wherein the photocatalyst at least partially wraps around an outside of the one or more light sources; and
a pure oxygen source coupled to the one or more reactors and configured to supply pure oxygen to the water sample;
analyzing the water sample that has been treated by the water treatment apparatus to measure a level of contaminants in the treated water sample;
providing the treated water sample for other uses if the measured level of contaminants is below a desired threshold; and
returning the water sample for further treatment in the water treatment apparatus if the measured level of contaminants is above a desired threshold.
